(19) United States
(12) Patent Application Publication
(10) Pub. No.: US 2003/0097618 A1
(43) Pub. Date: May 22, 2003

(54) Microcontroller capable of correcting program codes and method for driving the same

(76) Inventors: Yong-Un Kim, Ichon-shi (KR); Eun-Pyoung Lee, Ichon-shi (KR); In-Dong Yoon, Ichon-shi (KR)

Correspondence Address: JACOBSON, PRICE, HOLMAN & STERN, PROFFESSIONAL LIMITED LIABILITY COMPANY, 400 Seventh Street, N.W., Washington, DC, 20004, US

(21) Appl. No.: 10/298,550

(22) Filed: Nov. 19, 2002

(30) Foreign Application Priority Data
Nov. 19, 2001 (KR) 2001-0071827

(51) Int. Cl. H02H 3/05

(52) U.S. Cl. 714/39

(57) ABSTRACT

A microcontroller includes a central processing unit, a mask read only memory (ROM) storing a set program codes and corresponding program code addresses for operating the microcontroller, wherein the program codes includes at least one bug-found program code, a programmable ROM for storing at least one bug-corrected program code and a bug-corrected program code address, wherein the bug-corrected program code is correspondent to a bug-found program code and a correction block for comparing an address for a program code to be executed in the central processing unit and the bug-corrected program code address and, if said two addresses are matched each other, for generating a match signal for ceasing a read-out operation of the ROM in response to a fetch signal issued from the central processing unit to thereby allow the bug-corrected program code to be executed in the central processing unit.

### FIELD OF THE INVENTION

The present invention relates to a microcontroller; and, more particularly, a microcontroller capable of correcting program codes having a program bug by using a fetch signal of a central processing unit (CPU) in an effective manner.

### DESCRIPTION OF RELATED ART

A microprocessor is a semiconductor device integrating a central processing unit (CPU) on a single integrated circuit chip (IC). The microprocessor is initially developed by Intel Corp. in U.S.A. in 1971.

The microprocessor is a kind of CPU; however, it does not mean that all of CPUs are the microprocessor. Since the typical microprocessor is fabricated by integrating all the CPU components having an arithmetic and logic unit (ALU), a control unit, registers and so forth except a main memory on a single IC chip, the microprocessor can process some functions including operation, control and so on. These functions of the microprocessor are similar to those of a CPU for a large-scale computer.

A small computer using the microprocessor for the CPU is called as a microcomputer and a large-scale computer, which is larger than the minicomputer, is designed by using a plurality of CPUs. AS the microcomputer is designed by using on one-chip microprocessor as its CPU, the microcomputer can be simply configured. Accordingly, the microcomputer can be small-sized and lightened. Also, a low power consumption and a low fabrication cost thereof are expected. In addition, since the number of the elements configuring the microcomputer is reduced, there is an effect that reliability of the microcomputer is increased.

The structural difference between the microcomputer and the large-scale computer or a minicomputer is that the microprocessor has been used as the CPU in the microcomputer.

On the other hand, a microcontroller generally includes a microprocessor, a storage device, such as a ROM, RAM or the like, and an input/output control interface circuit, which are fabricated on a single chip. Although the microprocessor has been universally used, the microcontroller has been introduced from the middle of 1970s. The microcontroller has been used not for a universal purpose but for a control of various systems including the computer system. Since the microcontroller has a complete computer system including a storage device as one chip, it is called as one-chip or single-chip microcomputer.

When the microcontroller is used in a control application system instead of use for the universal microprocessor or hardware logic, there are advantages as follows:

\mathring{1} The control application system is small-sized and lightened. Since the controller in the control application system can be simply configured with only one chip microcontroller and a small number of system elements, a weight and size of the control application system are considerably decreased and, also, a power consumption thereof is decreased. In addition, the power supply can be also small-sized and lightened.

\mathring{2} A cost of the control application system becomes cheaper. Since the controller is simplified, a cost for control application system elements, a manufacturing cost and a developing cost are decreased and the developing period of the control application system is also reduced.

\mathring{3} Reliability of the control application system is improved. Since the microcontroller of the control application system can be simplified, the number of the control application system elements may be reduced and a reliable computer system is expected. Therefore, such a control application system trouble rate may be reduced and maintenance for the control application system becomes easy.

\mathring{4} Adaptability of the microcontroller is improved. Since some functions can be processed by software instead of a hardware, variation and extension of the functions for the microcontroller are adaptable to various applications.

A conventional microcontroller typically includes a CPU, a memory having a limited capacity, which is basically SRAM, EPROM or flash memory, an interrupt controller, a serial and parallel interface and counter/timer. Recently, a high efficient I/O function such a DMA controller, a high-speed serial communication function, an A/D converter, a PWM output and a PLL circuit are added in the microcontroller, so that use of the microcontroller in the computer system becomes more convenient.

Such a microcontroller has been developed with various types and models to be adapted in each application field. The microcontroller is called as MCU (microcontroller unit or microcomputer unit) distinguished from a universal microprocessor.

FIG. 1A is a schematic block diagram illustrating a conventional microcontroller.

As shown, the microcontroller includes a mask read only memory (ROM) 1, a random access memory (RAM) 2, a data bus 4, an address bus 5 and a CPU 3. Considering an operation of the microcontroller, the CPU 3 sends a desired address to the mask ROM 1 storing data, such as program codes for performing the operation of the microcontroller. The data of the mask ROM 1 are inputted into the CPU 3 through the data bus 4. The data inputted into the CPU 3 is processed and the processed data is then stored in the RAM 2 or is additionally processed in the CPU 3.

Generally, a set of program codes for performing an operation of the microcontroller are stored in the mask ROM 1. A process for inserting the program codes into the mask ROM 1 is carried out in a semiconductor manufacturing process. When manufacturing the microcontroller, the program codes are previously verified through the use of a test program and then the program codes are recorded or stored in the mask ROM 1 during the semiconductor manufacturing process. The program codes recoded in the mask ROM 1 have corresponding addresses, respectively.

When a program bug is found in the program codes, such a program bug should be removed so that a bug-free microcontroller is manufactured during the semiconductor manufacturing process. However, the above endeavor for obtaining the bug-free microcontroller during the semiconductor manufacturing process requires a high cost and a long remedy term over 2 to 3 months, so that time loss is severely caused and the bug-found chip after the semiconductor manufacturing process cannot be used any more.

After the semiconductor manufacturing process, when a program bug still remains in a microcontroller, if the program bug can be remedied only by correcting a few bytes of the program codes, another solution correcting the program bug instead of newly manufacturing the chip will be useful. Such a solution will be described hereinafter referring to FIG. 1B.

FIG. 1B is a block diagram illustrating another conventional microcontroller improved from the microcontroller shown in FIG. 1A.

As shown, the microcontroller further includes a programmable ROM 7, a register 8 and a comparator 9 compared with the microcontroller of FIG. 1A. After manufacturing the mask ROM 1, when the program bug in the program codes stored in the mask ROM 1 is found, a program code, which the program bug exists, is corrected and then the bug-corrected program code is stored in the programmable ROM 7. When an initial operation of the microcontroller is carried out, an address corresponding to the bug-corrected program code is inputted into the register 8 through the data bus 4.

The comparator 9 receives a first address signal of a program counter 6 in the CPU 3 through the address bus 5 and a second address signal of the register 8 to compare two address signals. If the first address signal and the address second signal are matched, an interrupt signal is generated from the CPU 3. When the interrupt signal is generated, the data in the mask ROM 1 is not inputted into the CPU 3 and the bug-corrected program code is inputted into the CPU 3 from the programmable ROM 7 through the data bus 4.

However, recently, a microcontroller capable of performing a program code correction of the mask ROM without using the interrupt signal from the CPU is required. Also, when the bug-existing program codes are found at many places in the mask ROM 1, a system, which the microcontroller can efficiently execute the bug-corrected program codes, is required.

### SUMMARY OF THE INVENTION

It is, therefore, an object of the present invention to provide a microcontroller capable of executing a bug-corrected program without newly manufacturing a bug-found microcontroller chip and a method for operating the same.

In accordance with an aspect of the present invention, there is provided a microcontroller comprising: a central processing unit; a first storage means storing a set program codes and corresponding program code addresses for operating the microcontroller, wherein the program codes includes at least one bug-found program code; a second storage means for storing at least one bug-corrected program code and a bug-corrected program code address, wherein the bug-corrected program code is correspondent to a bug-found program code; and a correction means for comparing an address for a program code to be executed in the central processing unit and the bug-corrected program code address and, if said two addresses are matched each other, for generating a match signal for ceasing a read-out operation of the first storage means in response to a fetch signal issued from the central processing unit to thereby allow the bug-corrected program code to be executed in the central processing unit.

In accordance with another aspect of the present invention there is provided a method for driving a microcontroller, comprising the steps of: storing a set program codes and corresponding program code addresses for operating the microcontroller in a first memory, wherein the program codes includes at least one bug-found program code; storing at least one bug-corrected program code and a corresponding bug-corrected program code address in a second memory, wherein the bug-corrected program code is correspondent to the bug-found program code; and comparing an address for a program code to be executed in a central processing unit and the bug-corrected program code address and, if said two addresses are identical to each other, generating a match signal for ceasing a read-out operation of the first memory in response to a fetch signal issued from a central processing unit to thereby allow the bug-corrected program code to be executed in the central processing unit.

### BRIEF DESCRIPTION OF THE DRAWINGS

The above and other objects and features of the instant invention will become apparent from the following descriptions of preferred embodiments taken in conjunction with the accompanying drawings, in which:

FIG. 1A is a schematic block diagram illustrating a conventional microcontroller;

FIG. 1B is a block diagram illustrating another microcontroller improved from the microcontroller shown in FIG. 1A;

FIG. 2 is a block diagram illustrating a microcontroller in accordance with one embodiment of the present invention;

FIG. 3 is a detailed block diagram illustrating a correction unit 700 in FIG. 2;

FIG. 4 is a block diagram illustrating a jump command generation unit 720 in FIG. 3;

FIG. 5 is a timing diagram showing an operation of a ROM 200 and a jump command generation unit;

FIG. 6 is a block diagram illustrating a microcontroller capable of correcting a plurality of bugs in accordance with another embodiment of the present invention;

FIG. 7 is a block diagram illustrating a multi-correction block 700A in FIG. 6;

FIG. 8 is a block diagram illustrating a jump command generation unit 750 in FIG. 7;

FIG. 9 is an explanation diagram illustrating a storage for storing the total address bits in accordance with one embodiment of the present invention;

FIG. 10 is an explanation diagram illustrating allocation of the addresses in accordance with one embodiment of the present invention;

FIG. 11 is an explanation diagram showing a mapping process of the address of the shared correction RAM; and

FIG. 12 is a explanation diagram showing a storage of the address.

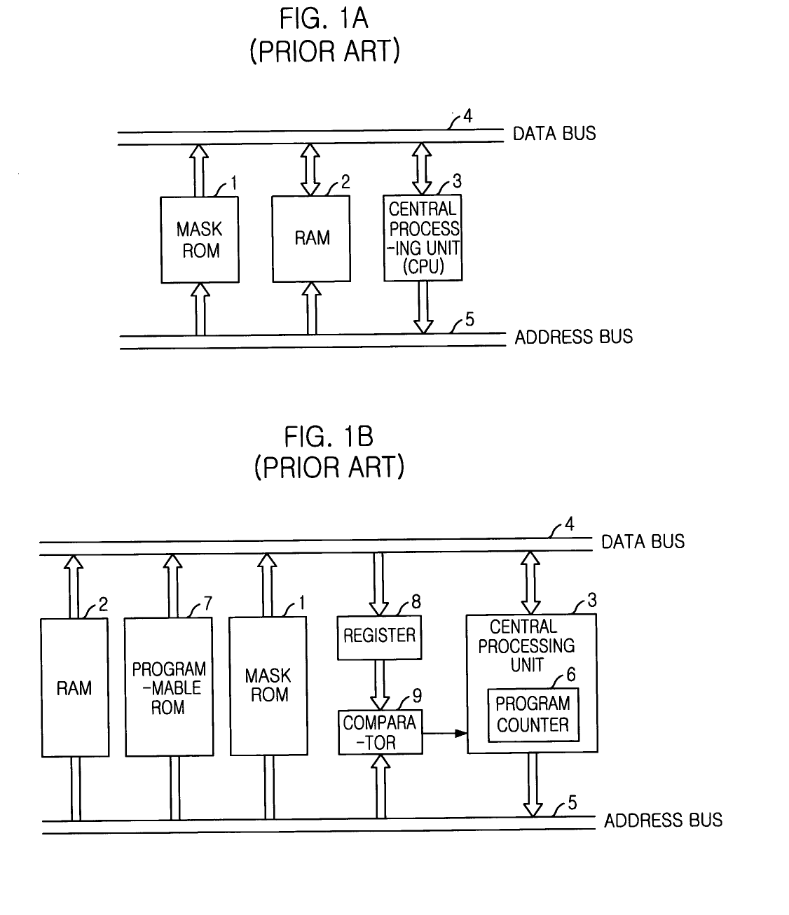

### DETAILED DESCRIPTION OF THE INVENTION

Hereinafter, an apparatus and method for correcting program codes having a program bug in a microcontroller in accordance with a preferred embodiment of the present invention will be described in detail referring to the accompanying drawings.

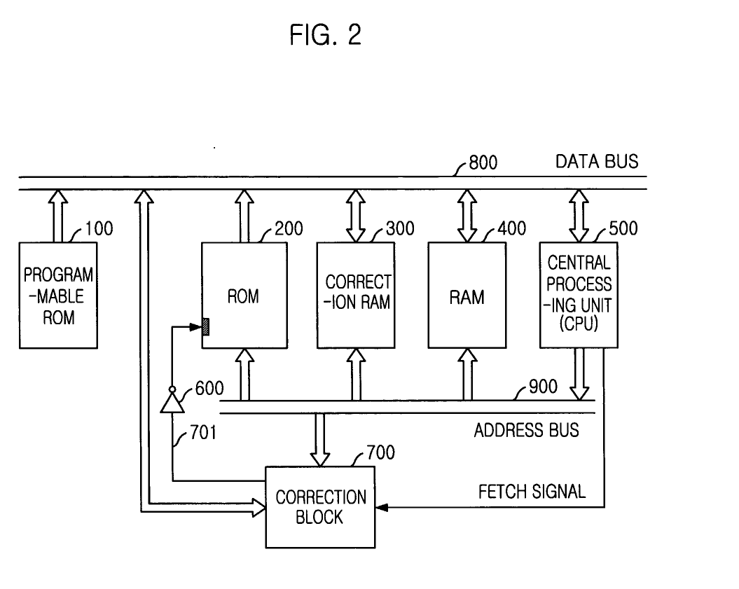

FIG. 2 is a block diagram illustrating a microcontroller in accordance with one embodiment of the present invention.

As shown, the microcontroller includes a ROM 200, a RAM 400, a programmable ROM 100, a correction RAM 300, a correction block 700 and a central processing unit (CPU) 500. The ROM 200 stores a program, which consists of codes and addresses, for operating the microcontroller and the RAM 400 stores data, such as program codes and the corresponding addresses processed in the CPU 500, during the microcontroller operation. The programmable ROM 100 stores one or more bug-corrected program codes, and addresses and bug-found addresses corresponding to bug-found program codes, which mean a program bug exists therein, stored in the ROM 200. The correction RAM 300 downloads the bug-corrected program codes and addresses from the programmable ROM 100 when an initial operation of the microcontroller just starts. When an address of a program code from the ROM 200, which will be processed in the CPU 500, is compared with that of the bug-found program code, which are downloaded from the programmable ROM 100. If matched, a read operation of the ROM 200 is temporarily stopped and a command, e.g., a jump command, for executing the bug-corrected program code in the correction RAM 300 is generated from the correction block 700. The CPU 500 controls the operation of the microcontroller through a data bus 800 and an address bus 900. A numeral reference denoted as 600 represents an inverter for inverting a ROM disable signal generated from the correction unit 700.

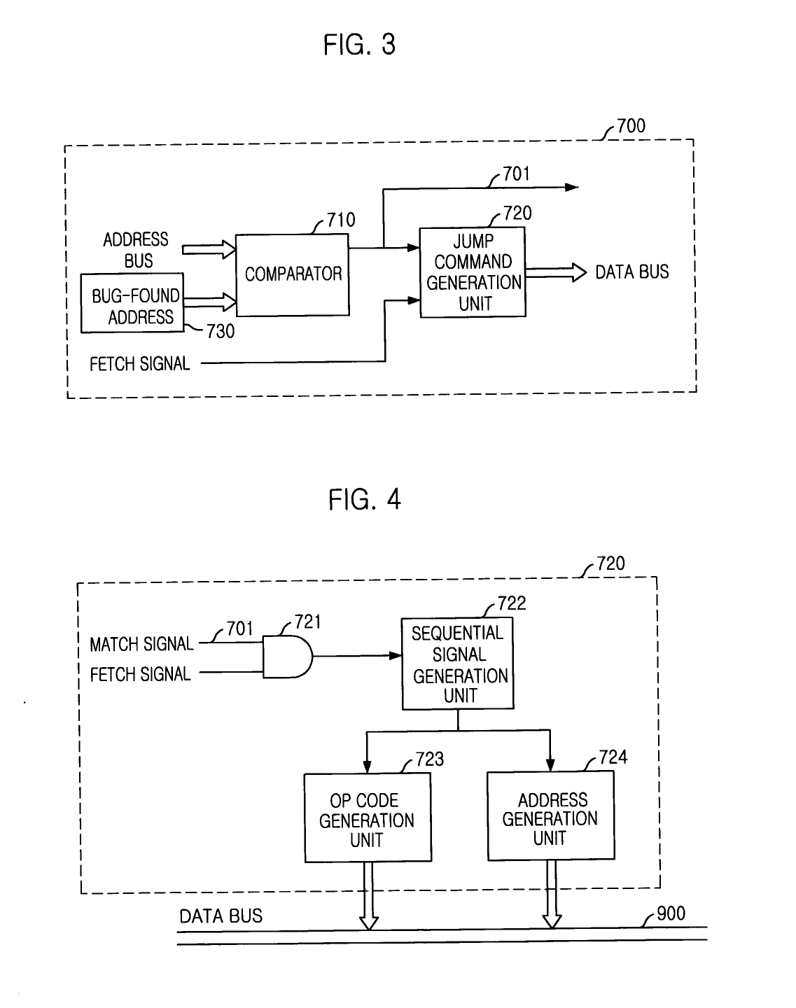

FIG. 3 is a detailed block diagram illustrating the correction block 700 in FIG. 2.

As shown, the correction block 700 includes a comparator 710, a jump command generation unit 720 and a bug-found address storage 730. The comparator 710 compares an address of a program code to be processed, which is currently on the address bus 900, with the bug-found address stored in the bug-found address storage, which is downloaded from the programmable ROM 100, to thereby generate a match signal. The jump command generation unit 720 generates a jump command selected from executive commands of the microcontroller in order to change an address of a program code to be processed to that of the bug-corrected program code in the correction RAM 300 in response to a fetch signal from the CPU 500.

FIG. 4 is a block diagram illustrating the jump command generation unit 720 in FIG. 3.

As shown, the jump command generation unit 720 includes a sequential signal generation unit 722, an OP code generation unit 723 and an address generation unit 724. The sequential signal generation unit 722 controls operations for generating the jump command and the address to be sequentially outputted to the data bus 800 according to the match signal and a fetch signal from the CPU 500. The OP generation unit 723 generates OP codes, which are program codes for the jump command, according to a control signal of the sequential signal generation unit 722 and the address generation unit 724 generates the address of bug-corrected program code to be processed. A numeral reference 721 denoted in FIG. 4 represents an AND gate for outputting the jump command by combining the match signal and the fetch signal of the CPU 500.

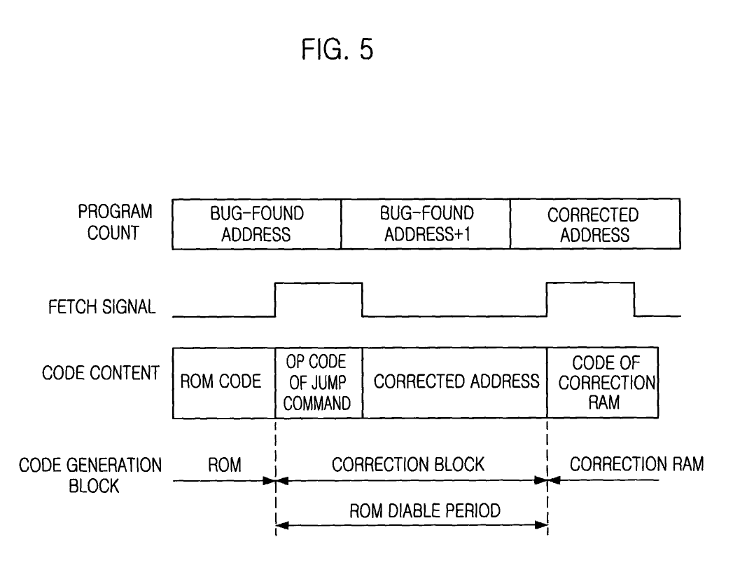

FIG. 5 is a timing diagram showing an operation of the ROM 200 and OP code generation for the jump command in response to a fetch signal.

As shown, when the address of program code to be executed in the CPU 500 is matched with that of the bug-found program code, the ROM 200 is disabled and the OP code of the jump command and the address to be jumped are sequentially generated. Therefore, the bug-corrected program code stored in the correction RAM 300 is executed in the CPU 500.

Referring to FIGS. 2 to 5, an operation of the microcontroller in accordance with one embodiment of the present invention will be described.

When an initial operation of the microcontroller is carried out, the bug-corrected program code is downloaded from the programmable ROM 100 to the correction RAM 300 together its address and then the program codes in the ROM 200 is read-out and executed, in a typical operation order, in the CPU 500.

Before the program codes in the ROM 200 are executed in the CPU 500, the comparator 710 determines whether the current address of the program code read out from the ROM 200 is matched with the bug-found address stored in the bug-found address storage 730. If the current address is matched with the bug-found address, the match signal 701 is outputted to the ROM 200. The read operation of the ROM 200 is temporarily stopped by the match signal 701 so that an execution operation for the program code in the ROM 200 is stopped. Namely, the match signal 701 is employed as a ROM disable signal to stop the execution operation for the program code to be executed. And then, the jump command for changing an address of the bug-found program code stored in the ROM 200 into that of the bug-corrected program code stored in the correction RAM 300 is generated in the jump command generation unit 720 according to the match signal 701 and the fetch signal from the CPU 500.

In order to synchronize program code execution operations of microcontrollers, the fetch signal of the CPU is used to receive a next program code synchronized with a clock signal after one program code is executed. Recently, even if various methods, such as a prefetch method or the like, are used to recognize a program execution timing in various kinds of CPUs, it is difficult to accurately recognize when a program code is generated, so that an accurate timing process is implemented by using the fetch signal of the CPU 500.

A first control signal and a second control signal from the sequential signal generation unit 722 are transmitted into the OP code generation unit 723 and the address generation unit 724 and then the OP code of the jump command is generated from the OP code generation unit 723. An address signal-to be jumped is generated from the address generation unit 724.

Also, an address of the bug-found program code may be changed into that of the bug-corrected program code in the correction RAM 300 in response to other available commands according to kinds of microcontroller instead of use of the jump command.

Referring to FIG. 5, when an address of a program code to be executed in the CPU 500 is matched with that of the bug-found address stored in the bug-found address storage 730, the address for the bug-found program code to be executed in the CPU 500 is changed to that of the bug-corrected program code stored in the correction RAM 300 by generating the jump command in synchronization with the fetch signal from the CPU 500 so that a read operation of the ROM 200 is temporarily stopped. The reason temporarily stopping the operation of the ROM 200 is to prevent the CPU 500 from continuously executing the bug-found program code.

The ROM 200 is temporarily stopped until the jump address signal is disappeared. Namely, the ROM 200 is disabled during a period of which one jump command is enabled. Accordingly, the bug-found program code in the ROM 200 is not transmitted into the data bus 800 and an execution order of the program codes can be changed into the bug-corrected program code in the correction RAM 300.

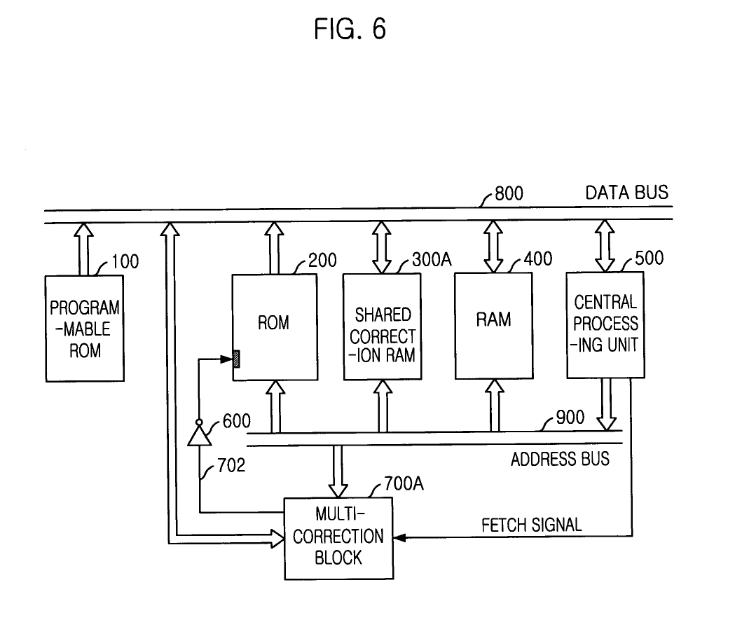

Also, the program bugs may be occurred at a number of program codes. FIGS. 6 to 8 illustrate another conventional microcontroller capable of executing a number of bug-corrected program codes contained in the correction RAM 300.

Referring to FIG. 6, the microcontroller includes a ROM 200, a RAM 400, a programmable ROM 100, a shared correction RAM 300A, a multi-correction block 700A and a CPU 500.

The ROM 200 initially stores a plurality of program codes for operating the microcontroller and the RAM 400 stores data, such as program codes and corresponding addresses processed in the CPU 500 during an operation of the microcontroller. The programmable ROM 100 stores a number of bug-corrected program codes corresponding a number of bugs existing in the program codes initially stored in the ROM 200 and the shared correction RAM 300A receives the bug-corrected program codes from the programmable ROM 100 in an initial operation of the microcontroller together with their addresses. The programmable ROM 100 further stores a number of bug-found addresses corresponding to a number of bug-found program codes initially stored in the ROM 200.

When an address of a program code to be executed in the CPU 500 is matched with the bug-found address downloaded from the programmable ROM 100 to the multi-correction block 700A, the multi-correction block 710A generates a command, i.e., the jump command, to temporarily stop a read operation of the ROM 200 and then the bug-corrected program code in the correction RAM 300A is executed in the CPU 500. The CPU 500 controls an operation of the microcontroller through a data bus 800 and an address bus 900. The CPU 500 includes a program counter (not shown) for counting the address of the program codes to be executed in the CPU 500. A reference numeral 600 represents an inverter to invert a ROM disable signal generated from the multi-correction block 700A.

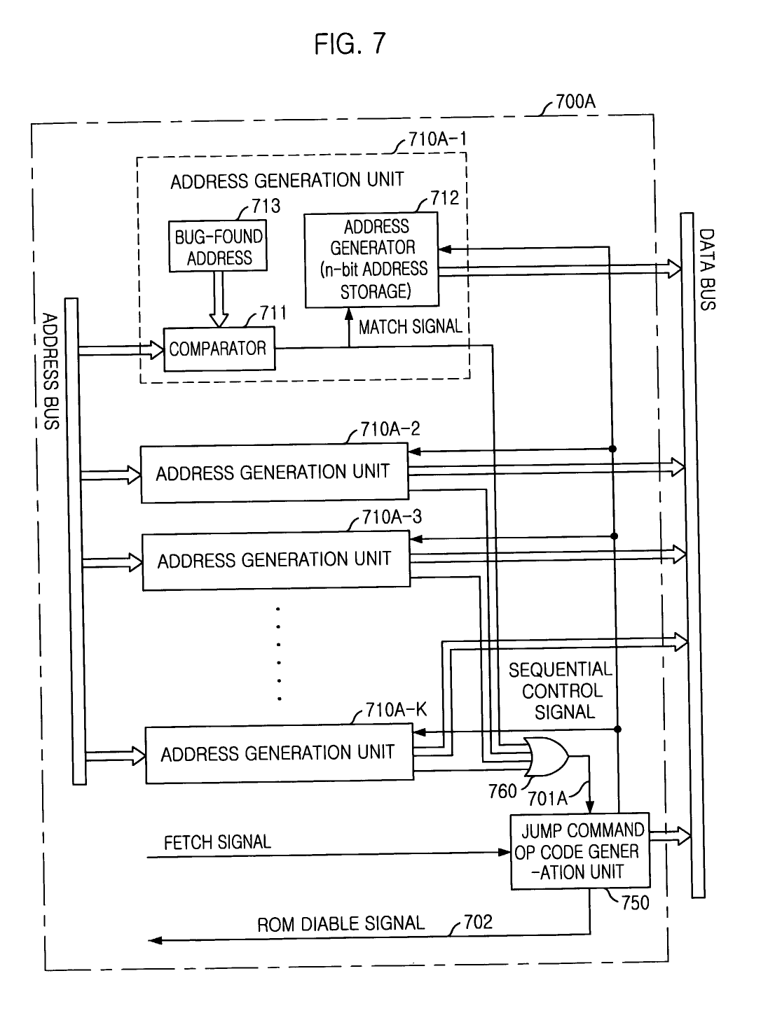

Referring to FIG. 7, the multi-correction block 700A includes a plurality of address generation units 700A-1, 700A-2, 700A-3, . . . , 700A-k arranged in correspondence with the number of addresses for the bug-found program codes in the ROM 200 and an OP code generation unit 750, wherein k is a possible integer.

When the address of the program code to be executed is matched with a bug-found address stored in a bug-found address storage 713, which is downloaded from the programmable ROM 100, one of the address generation units 700A-1, 700A-2, 700A-3, . . . , 700A-k outputs a match signal and an address for a bug-corrected program code. The OP code generation unit 750 generates an OP code signal of the jump command and a ROM disable signal 702 to change the address of the bug-found program code into that of the bug-corrected program code in the correction RAM 300A in response to the fetch signal of the CPU 500.

When an address of the program code to be executed and an address stored in the bug-found address storage 713 are matched, an OR gate 760 receiving a plurality of outputs of the plurality of addresses generation units 700A-1, 700A-2, 700A-3, . . . , 700A-k is to generate a match signal 701A.

Also, the address generation unit 700A-1 includes a comparator 711 for outputting a match signal when the address of the executed program code to be executed and the address of the bug-corrected program code are matched and an address generator 712 for generating an address corresponding to a program code in the correction RAM 300A.

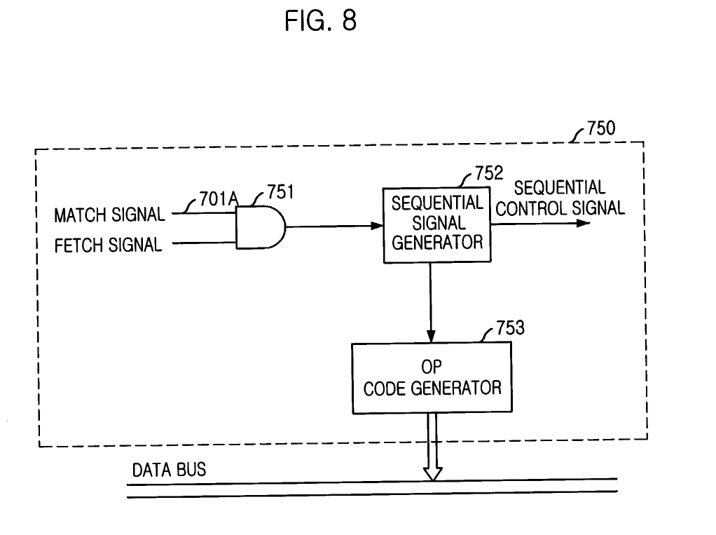

Referring to FIG. 8, the OP code generation unit 750 includes an AND gate 751, a sequential signal generator 752 and an OP code generator 753. The AND gate 751 receives the match signal 701A and the fetch signal from the CPU 500 as its inputs and outputs a jump command. The sequential signal generator 752 generates a sequential control signal for controlling an OP code generation for the jump command in response to an output signal of the AND gate 751. The OP code generator 753 generates OP codes for the jump command according to a control signal of the sequential signal generator 752.

Subsequently, when a plurality of program bugs are found in program codes initially stored in the ROM 200 for operating the microcontroller, an operation for correcting the program bugs will be described.

In an initial operation of the microcontroller, the bug-corrected program codes are downloaded from the programmable ROM 100 to the shared correction RAM 300A and the bug-found addresses are downloaded to the bug-found address storage 713 in each address generation unit 700A-1, 700A-2, 700A-3, . . . 700A-k. The program codes in the ROM 200 are sequentially executed under the control of the CPU 500 and one of the address generation units 700A-1, 700A-2, 700A-3, . . . , 700A-k in the multi-correction block 700A detects whether the address of a program code to be executed in the CPU 500 corresponds to the bug-found address stored in the bug-found address storage 713. If two addresses are matched each other, a match signal and a jump command for changing the address the program code to be executed in the CPU 500 into that of the bug-corrected program code in the shared correction RAM 300A are outputted from the multi-correction block 700A.

Considering the generation of the jump command, when the match signal is generated, the OP code generation unit 750 generates a ROM disable signal 702 temporarily stopping the ROM 200 in synchronization with the fetch signal of the CPU 500 and the OP code for the jump command and then a sequential control signal is outputted into each address generation unit 700A-1, 700A-2, 700A-3, . . . , 700A-k.

The address for the bug-corrected program code in the shared correction RAM 300A is generated from a specific one of the plurality of address generation units 700A-1, 700A-2, 700A-3, . . . , 700A-k in accordance with the sequential control signal outputted from the OP code generation unit 750 and the match signal outputted from the comparator 711. This address and the OP code generated from the OP code generator 753 are summed, so that the jump command is generated.

Considering an internal operation of the OP code generation unit 750, the sequential signal generator 752 sequentially outputs a signal for generating the OP code for the jump command and the sequential control signal in synchronization with the match signal 701A and the fetch signal from the CPU 500. The control signal for generating the OP code generation signal is inputted into the OP code generator 753 from the sequential signal generator 752 and then the OP code of the jump command is generated from the OP code generator 753. The sequential control signal is inputted into the plurality of address generation units 700A-1, 700A-2, 700A-3, . . . , 700A-k. The plurality of address generation units 700A-1, 700A-2, 700A-3, . . . , 700A-k in the multi-correction block 700A output address signals in accordance with the sequential control signal and the match signal outputted from the comparator 711.

FIG. 5 is a timing diagram showing generation of the ROM disable signal 702 and the jump command. Also, other commands instead of the jump command can be properly used in accordance with kinds of the controller.

As mentioned the above, in order to correct a plurality of program bugs, the address signals are generated in plurality of address generation units 700A-1, 700A-2, 700A-3, . . . 700A-k in the microcontroller and the OP code for the jump command is generated from the OP code generation unit 723, which is commonly used in the microcontroller, so that an area of the circuit configuring the microcontroller can be reduced.

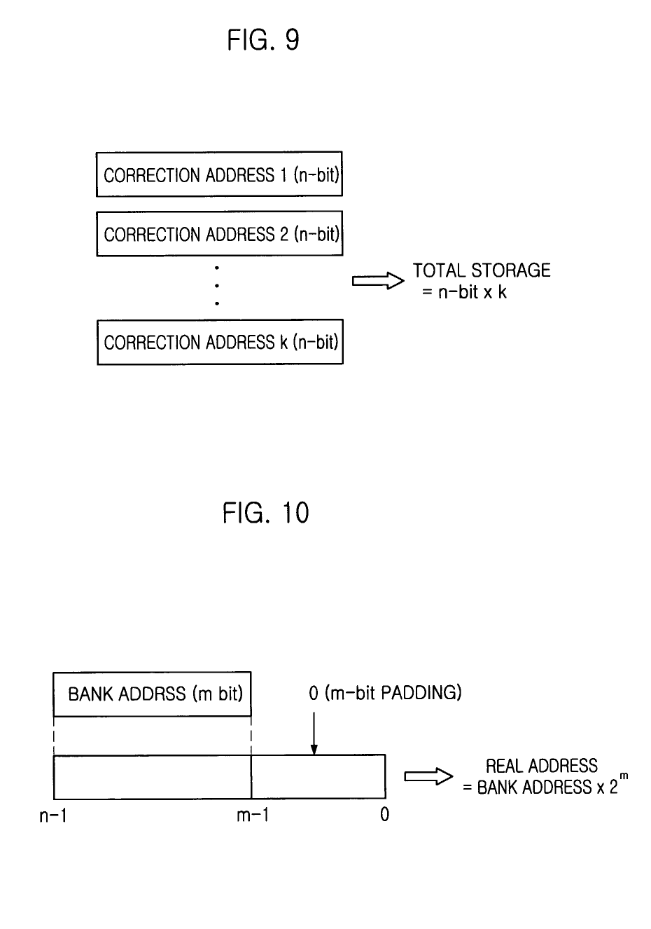

Referring to FIG. 9, an address to be jumped to the shared correction RAM 300A is issued after being stored in the address generator 712 in the each address generating unit 700A-1, 700A-2, 700A-3, . . . , 700A-k. In order to generate an n-bit address corresponding to an n-bit address bus, n-bit data has to be stored in the address generator 712. Accordingly, if the number of the address generation units is k, a storage of n*k bits are required, wherein n is a positive integer.

In order to reduce the address storage in the address generator 712, the present invention suggests an approach of a bank unit as follows. Addresses to be jumped are treated not with a bit unit, but a bank unit, so that the storage memory can be reduced.

Referring to FIG. 10, when the address bus is n-bit address bus, in an n-bit address for the correction RAM 300, the lower m-bit block is assigned as “0” and the upper (n-m)-bit block is assigned as a bank address. Accordingly, the actual address becomes (n-m)*2^{m} bits, m being a positive integer.

Namely, (n-m)-bit data is stored in the address storage in the address generator 21 and, when the address to be jumped is generated, the lower m-bit is filled with “0” (m-bit padding). Accordingly, a mapping process for all addresses in the shared correction RAM 300A is performed with a block of 2^{m}-bit unit. When k numbers of address generation units are used in the multi-correction block 700A, the whole address storage becomes (n-m)*k bits.

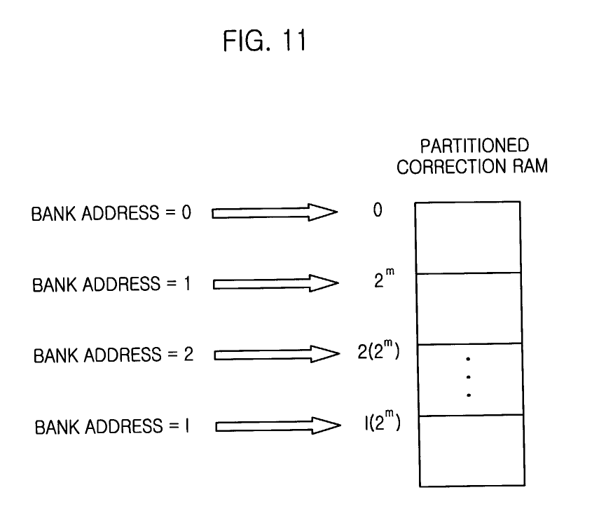

FIG. 11 is a diagram showing a mapping process for the address in the shared correction RAM 300A.

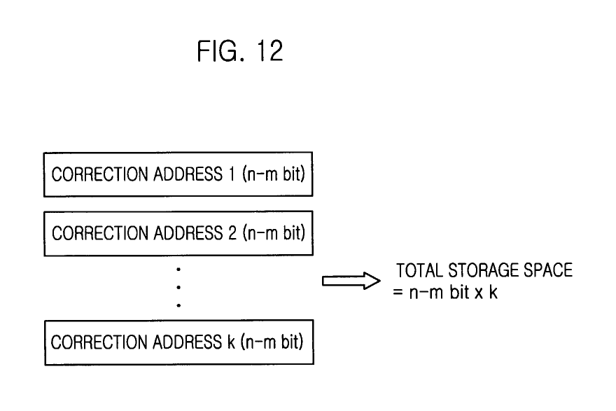

FIG. 12 is a diagram showing an address storage for each address generator in each address generation unit. The whole address storage is (n-m)*k bits.

When a plurality of program bugs are occurred in the program codes initially stored in the ROM 200, the bug-found program codes can be corrected with data stored in the multi-correction RAM, so that fabrication time and cost can be efficiently reduced.

When several program codes of the ROM built in the microcontroller have to be corrected, several distributed units including the jump command generation unit are only required in accordance with the present invention so that the bug-corrected program codes can be easily executed through the minimum circuit area.

Also, even if a program bug is not occurred, when a user want to modify the program codes, the program codes can be easily modified in accordance with present invention.

While the present invention has been described with respect to the particular embodiments, it will be apparent to those skilled in the art that various changes and modifications may be made without departing from the spirit and scope of the invention as defined in the following claims.

What is claimed is:

1. A microcontroller comprising:
a central processing unit;
a first storage means storing a set program codes and corresponding program code addresses for operating the microcontroller, wherein the program codes includes at least one bug-found program code;
a second storage means for storing at least one bug-corrected program code and a bug-corrected program code address, wherein the bug-corrected program code is correspondent to a bug-found program code; and
a correction means for comparing an address for a program code to be executed in the central processing unit and the bug-corrected program code address and, if said two addresses are matched each other, for generating a match signal for ceasing a read-out operation of the first storage means in response to a fetch signal issued from the central processing unit to thereby allow the bug-corrected program code to be executed in the central processing unit.

2. The microcontroller as recited in claim 1, further comprising:
a third storage means for temporarily storing program codes processed by the central processing unit during the microcontroller operation; and
a fourth storage means for storing at least one bug-corrected program code and the bug-corrected program code address, which are downloaded from the second storage means in an initial microcontroller operation.

3. The microcontroller as recited in claim 2, wherein the first storage means is a read only memory (ROM).

4. The microcontroller as recited in claim 2, wherein the second storage means is a programmable read only memory (ROM).

5. The microcontroller as recited in claim 2, wherein the correction means includes:
a fifth storage means for storing a bug-found program code address;
a comparison unit for comparing the address to be executed in the central processing unit with the bug-found program code address and, if said two addresses are matched each other, generating the match signal; and
a command generation unit for generating a command to change the address to be executed to the bug-corrected program address in response to the match signal and the fetch signal.

6. The microcontroller as recited in claim 5, wherein the command generation unit includes:
a sequential signal generation unit for sequentially outputting a first and a second control signals in response to the match signal and the fetch signal;
a OP code generation unit for generating an OP code for the command in response to the first control signal; and
an address generation unit for generating an address corresponding to the bug-corrected program code address stored in the fourth storage means in response to the second control signal.

7. The microcontroller as recited in claim 6, wherein the OP code is a jump command code.

8. The microcontroller as recited in claim 2, wherein the correction means includes:
a plurality of address generation units for sequentially comparing addresses to be executed in the central processing unit with bug-found program code addresses and, if said two addresses are matched each other, generating the match signal and the bug-corrected program code address stored in the fourth storage means; and
an OP code generation unit for generating an OP code for the command and a plurality of sequential control signals inputted into the plurality of address generation units in response to the fetch signal and the match signal.

9. The microcontroller as recited in claim 8, wherein each address generation unit includes:
a sixth storage means for storing the bug-found program code address;
a comparison unit for comparing the address to be executed in the central processing unit with the bug-found program code address and, if said two addresses are matched each other, generating the match signal; and
an address generator for generating an address corresponding to the bug-corrected program code address stored in the fourth storage means in response to the match signal and the sequential control signal.

10. The microcontroller as recited in claim 8, wherein the OP code generation unit includes:
an AND gate for outputting a jump command in response to the match signal and the fetch signal;
a sequential control signal generation unit for sequentially outputting the sequential control signal and an enable signal in response to the jump command signal outputted from the AND gate; and
a OP code generator for generating an OP code for the jump command in response to the enable signal.

11. The microcontroller as recited in claim 8, wherein the OP code generation unit generates a disable signal temporarily disabling a read-out operation of the first storage means in response to the fetch signal and the match signal.

12. The microcontroller as recited in claim 9, wherein the forth storage means has a plurality of banks for storing the bug-corrected program codes and the bug-corrected program addresses.

13. The microcontroller as recited in claim 12, wherein the address generator includes an address storage for storing an address corresponding to a bank address of the fourth storage means, wherein the bit number of the address storage is less than that of a bus for transmitting the address and, when the address is transmitted, the lower bits are filled with ‘0’ to match the bit number with that of the bus.

14. A method for driving a microcontroller, comprising the steps of:
storing a set program codes and corresponding program code addresses for operating the microcontroller in a first memory, wherein the program codes includes at least one bug-found program code;
storing at least one bug-corrected program code and a corresponding bug-corrected program code address in a second memory, wherein the bug-corrected program code is correspondent to the bug-found program code; and
comparing an address for a program code to be executed in a central processing unit and the bug-corrected program code address and, if said two addresses are identical to each other, generating a match signal for ceasing a read-out operation of the first memory in response to a fetch signal issued from a central processing unit to thereby allow the bug-corrected program code to be executed in the central processing unit.

15. The method as recited in claim 14, further comprising the steps of:
downloading at least on bug-corrected program code and the corresponding bug-corrected program address from the second memory to a third memory in an initial microcontroller operation; and
storing program codes processed by the central processing unit during the microcontroller operation.
